(19) United States
(12) Patent Application Publication
(10) Pub. No.: US 2009/0240884 A1
(43) Pub. Date: Sep. 24, 2009

(54) PLAYBACK APPARATUS FOR MULTIPLE MEMORY CARDS OF THE SAME TYPE

(76) Inventors: Ming-Feng CHEN, Taipei (TW); Chia-Tzu Hu, Taipei (TW)

Correspondence Address: HDLS Patent & Trademark Services, P.O. BOX 220746, CHANTILLY, VA, 20153-0746, US

(21) Appl. No.: 12/050,376

(22) Filed: Mar. 18, 2008

(51) Int. Cl. G06F 13/00

(52) U.S. Cl. 711/115; 711/E12.001

(57) ABSTRACT

A playback apparatus for multiple memory cards of the same type. The apparatus comprises of a plurality of memory card slots of the same type, a memory card selecting unit, a microprocessor unit and a multimedia processor. The microprocessor unit electronically connects to the memory card selecting unit, receiving a memory card detecting signal from the memory card selecting unit and sending a memory card selecting signal to the memory card selecting unit. The multimedia processor electronically connects to the processor unit and the memory card selecting unit, reading the data from one memory card through the memory card selecting unit under the control of the microprocessor unit. Hence the playback apparatus selects one of the multiple memory cards of the same type, playing audio/video signals stored in the memory card. User therefore can select multiple memory cards of the same type for playing.

### BACKGROUND OF THE INVENTION

1. Field of the Invention

The present invention relates to a playback apparatus for multiple memory cards of the same type, especially a playback apparatus for multiple memory cards of the same type that user selects multiple memory cards of the same type for playing.

2. Description of Prior Art

With the progress of the semiconductor technology, the capacity and security of memory cards, for example SD card, Mini SD card, MMC card and memory stick, increase a lot. User tends to buy multiple of memory cards of the same type for digital camera and cellular phone to store data. For example, user brings several SD cards to backup the photo taken by a digital camera during his trip.

In addition, multimedia devices for home or automobile equip with a card reader to read the MP3 or MP4 files stored in the memory card. However, these devices usually use only one memory card slot (or USB plug) to read the memory card and an adapter to select multimedia data from different sources, like cassette, CD, VCD and FM/AM, to play. Also these devices may equip with a multiple-in-1 (for example, 6-in-1) card reader for memory cards of different types (for example, SD/MMC/MS/MS Pro/SM/XD to PCMCIA.)

Unfortunately, customers tend to use multiple memory cards of the same type, like SD or MS cards, to prevent from compatible issue comes from different memory card type. Therefore, a playback apparatus for multiple memory cards of the same type can efficiently utilize the customers' memory cards.

### SUMMARY OF THE INVENTION

The object of the present invention is to provide a playback apparatus for user to select from multiple of memory cards of the same type for playing.

The present invention provides a playback apparatus for multiple memory cards of the same type. The apparatus reads at least one memory card and comprises of a plurality of memory card slots of the same type, a memory card selecting unit, a processor unit and a multimedia processor. The processor unit electronically connects to the memory card selecting unit, receiving a memory card detecting signal from the memory card selecting unit and sending a memory card selecting signal to the memory card selecting unit. The multimedia processor electronically connects to the processor unit and the memory card selecting unit, reading the data from one memory card through the memory card selecting unit under the control of the processor unit. Hence the playback apparatus for multiple memory cards of the same type selects one of the multiple memory cards of the same type, playing audio/video signals stored in the memory card. User therefore can select multiple memory cards of the same type for playing.

### BRIEF DESCRIPTION OF THE DRAWINGS

FIG. 1 is a diagram showing a playback apparatus for multiple memory cards of the same type according to a first embodiment of the invention.

FIG. 2A is a block diagram showing a playback apparatus for multiple memory cards of the same type according to a first embodiment of the invention.

FIG. 2B is a block diagram showing a playback apparatus for multiple memory cards of the same type according to a second embodiment of the invention.

FIG. 3A is a diagram showing the host reading multiple of SD cards under SD bus mode.

FIG. 3B is a diagram showing the host reading multiple of SD cards under SPI bus mode.

FIG. 4 is a circuit diagram corresponding to the block diagram in FIG. 2A, showing the operation under SD bus mode.

### DETAILED DESCRIPTION OF THE INVENTION

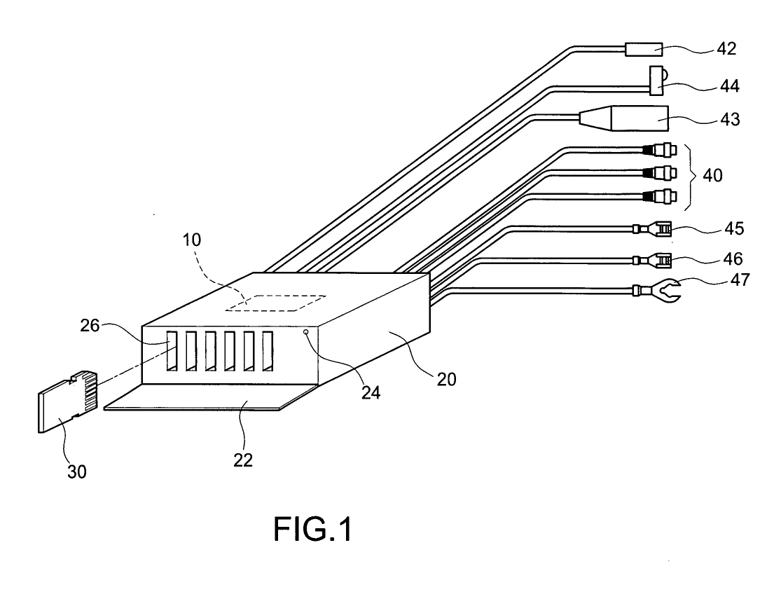

FIG. 1 is a diagram showing a playback apparatus for multiple memory cards of the same type 10 according to a first embodiment of the invention. The playback apparatus for multiple memory cards of the same type 10 can be mounted in a case 20 with a front cap 22 pivotally connected thereon and a front cap switch 24 sensing if the front cap 22 is closed. The case 20 comprises of a plurality of memory card slots 26 of the same type for user to insert multiple of memory cards of the same type 30. The memory cards 30 of the same type shown in the figure are SD cards and the number of memory card slots 26 is six. The embodiment of this invention has been presented for purposes of illustration and description. Different type or different number of the memory cards are within the scope of the present invention.

The playback apparatus 10 for multiple memory cards of the same type selectively reads the memory cards of the same type 30 then sends data to multimedia devices through cables, requiring power, sending or receiving control signals therefrom. As shown in FIG. 1, these cables includes digital output line 42, IR tranceiving line 44, panel I/O line 43, analog video/audio output lines 40, power switch line 45, power line 46 and ground line 47.

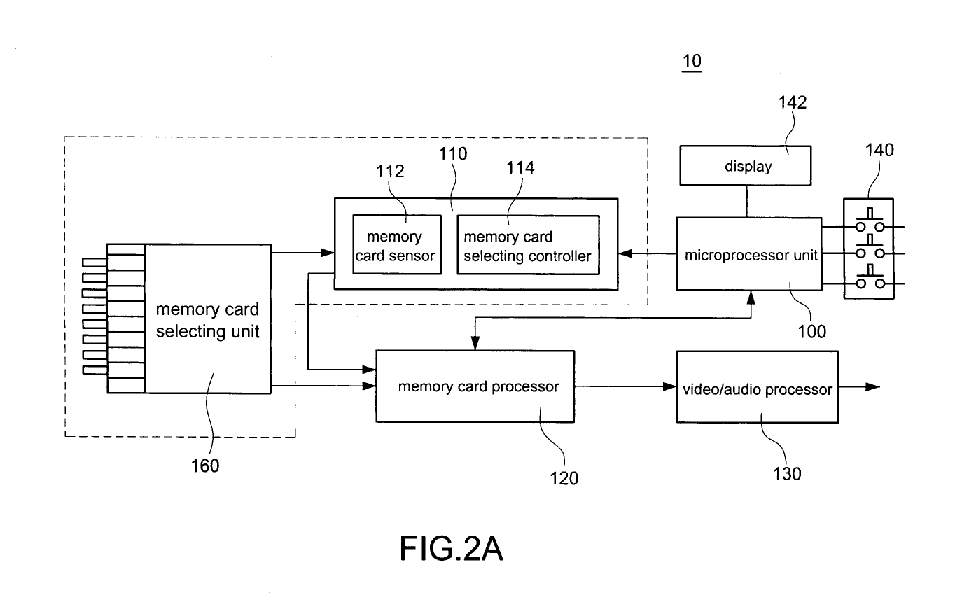

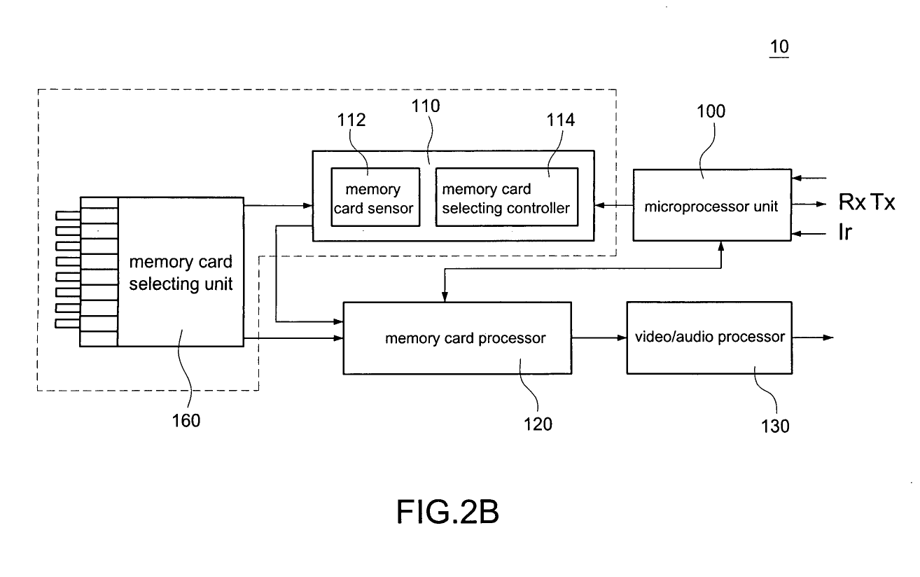

FIG. 2A is a block diagram showing a playback apparatus for multiple memory cards of the same type according to a first embodiment of the invention. The playback apparatus 10 for multiple memory cards of the same type is adopted in a multimedia device with multiple memory cards. The playback apparatus 10 comprising a microprocessor 100, a memory card control unit 110, a memory card processor 120, a video/audio processor 130 and a memory card selecting unit 160. The memory card selecting unit 160 contains a plurality of memory card selecting switches 162 (not shown) to selectively read the memory card 30 in a memory card slot 26. The memory card control unit 110 includes a memory card sensor 112 and a memory card selecting controller 114, where the memory card sensor 112 detects if there is any memory cards 30 in each memory card slot and the memory card selecting controller 114 selects a memory card 30 in one of the memory card slots 26 to read according to the commands from the microprocessor 100 set by a user operating the control switches 140. The memory card controller 120 reads the data stored in the memory card 30 selected by the memory card selecting controller 114 and sends it to the video/audio processor 130. The video/audio processor 130 sends the data in memory card 30 to a speaker (not shown) or a display monitor (not shown) as audio or video output and it is not described here.

The microprocessor 100 processes the user commands sending from the control switches 140 to control the memory card selecting controller 114 for selecting the memory card 30 from one of the memory card slots 26. In addition, the microprocessor 100 reads the information of memory card 30 sending from memory card sensor 112 (ex. number of memory cards, the location of the slots being occupied) and track number/time information transmitted from the memory card controller 120 in order to display them on a display 142.

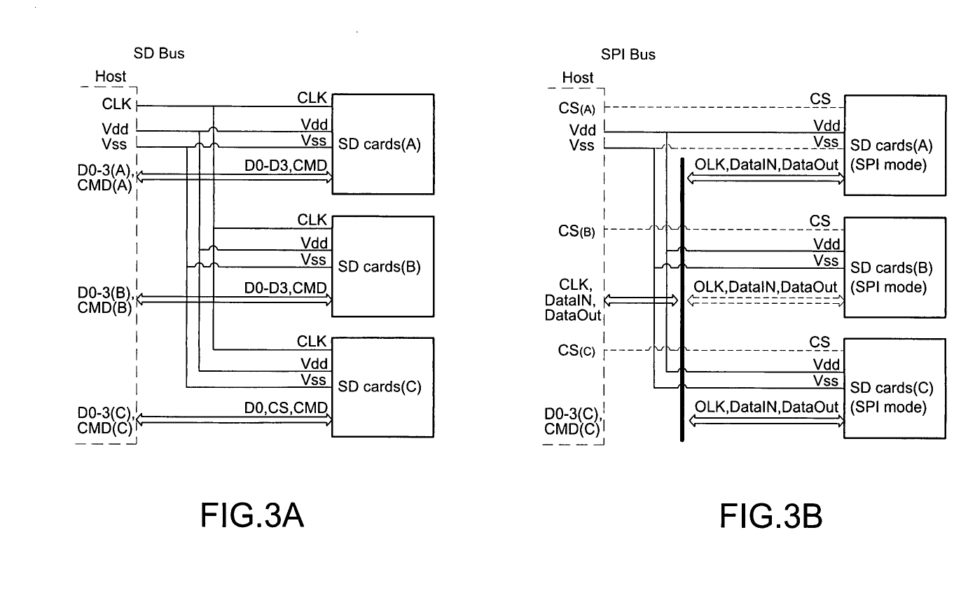

FIG. 3A and 3B takes SD cards as an example, demonstrating that the host reads multiple SD cards by SD bus mode and SPI bus mode. As shown in FIG. 3A, under the SD bus mode there must be a plurality groups of data port (DAT0˜DAT3) and command/response port (CMD) at the host in order to read multiple SD cards. At SPI bus mode, multiple SD cards are placed in parallel and a chip select signal (CS) decides which SD card is being used. In present invention, memory card processor 120 has multiple groups of chip select signal (CS) pin; therefore, it is applicable to either SD bus mode or SPI bus mode.

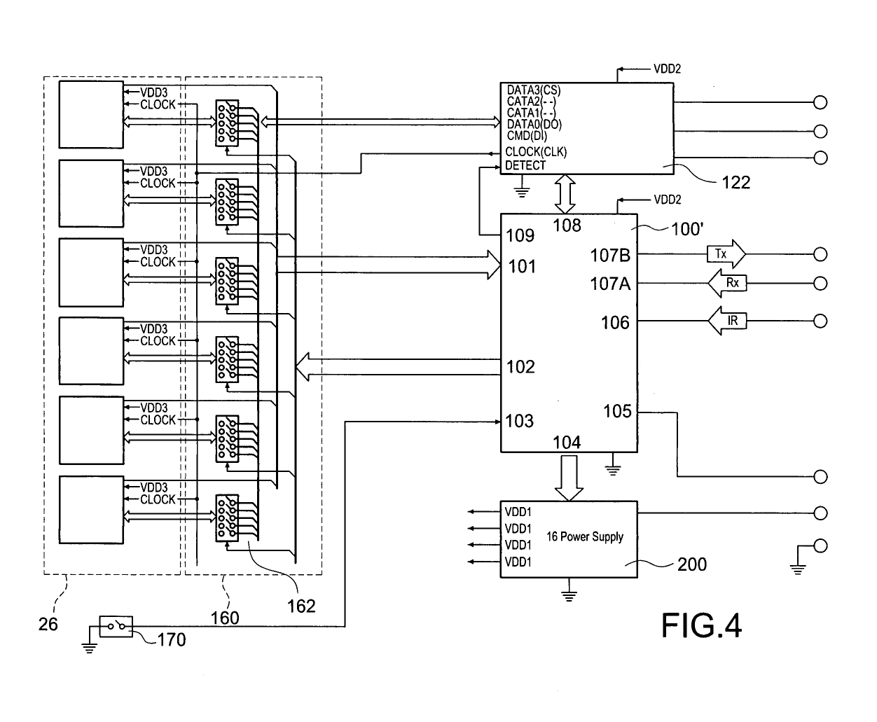

FIG. 4 is a circuit diagram corresponding to the block diagram in FIG. 2A, showing the operation under SD bus mode. In this circuit diagram, the memory card control unit 110 and the microprocessor 100 have been integrated in a microprocessor unit 100′ while the memory card processor 120 and the video/audio processor 130 are integrated into a multimedia processor 122 in order to simplify circuit layout. The playback apparatus for multiple memory cards of the same type in FIG. 4 also includes a front cap open/close sensor switch 170 electrically connecting to the microprocessor unit 100′, telling the microprocessor unit 100′ whether the front cap is open or closed. The multimedia device further contains a power supply 200 to provide power to the whole system. The microprocessor unit 100′ has a plurality of I/O ports, including memory card detect input port 101, memory card select output port 102, front cap detect input port 103, power control port 104, ACC detect port 105, IR input port 106, control signal input port 107A, control signal output port 107B, control command I/O port 108 and detect output port 109.

When the power is on and the microprocessor unit 100′ detects ACC switch is closed, the microprocessor unit 100′ will check if the front cap is closed. The microprocessor will send a “front cap not closed” information through control signal output port 107B if the front cap is not closed, while the microprocessor unit 100′ checks how many memory cards are there in the memory card slots 26 through the memory card detect input port 101 if the front cap is closed. If the memory card installed is the same as that of last power-on, the microprocessor unit 100′ controls the panel to display “continue playing”, meaning continue playing the content from last power-off. User can select a memory card by operating the buttons/panel or a remote control through the control signal input port 107A or IR input port 106, and the microprocessor unit 100′ will select the specific card through the memory card select output 102 according to the user command. The memory card selecting unit 160 selects a memory card for reading, and then the data on the selected memory card will be sent to the multimedia processor 122 through the memory card data bus. The multimedia processor 122 will process the data from the memory card and send it to audio output, video output or digital output.

FIG. 4 is another circuit diagram corresponding to the block diagram in FIG. 2A, showing the operation under SPI bus mode.

FIG. 2B is a block diagram showing a playback apparatus for multiple memory cards of the same type according to a second embodiment of the invention. The playback apparatus for multiple memory cards of the same type 10 is adopted in a automobile multimedia device with multiple memory cards, comprising units similar to those in FIG. 2A without a display 142. The display 142 is omitted since the operating panel and display of the automobile stereo system can be used for the playback apparatus for multiple memory cards of the same type for input command and video displaying.

Although the present invention has been described with reference to the preferred embodiment thereof, it will be understood that the invention is not limited to the details thereof Various substitutions and modifications have suggested in the foregoing description, and other will occur to those of ordinary skill in the art. Therefore, all such substitutions and modifications are intended to be embraced within the scope of the invention as defined in the appended claims.

What is claimed is:

1. A playback apparatus for multiple memory cards of the same type for playing electronic memory cards, comprising:
a plurality of memory card slots of the same type;
a memory card selecting unit electrically connecting to the memory card slots of the same type to select one of the memory card slots for playing;
a microprocessor unit electrically connecting to the memory card selecting unit, and configured for reading a memory card detecting signal sending from the memory card selecting unit and sending a memory card selecting signal to the memory card selecting unit; and
a multimedia processor electrically connecting to the microprocessor unit and the memory card selecting unit, and configured for reading data through the memory card selecting unit under the control of the microprocessor.

2. The apparatus as claimed in claim 1, wherein the microprocessor unit includes a microprocessor and a memory card control unit, wherein the microprocessor processes user command and commands to the multimedia processor, wherein the memory card control unit reads the memory card detecting signal from memory card selecting unit, and outputting the memory card selecting signal to the memory card selecting unit.

3. The apparatus as claimed in claim 2, wherein the memory card control unit comprises a memory card sensor and a memory card selecting controller, the memory card sensor detects each memory card slot to identify whether a memory card is inserted, and the memory card selecting controller selects the memory card from one of the memory card slots for playback according to user command sending from the microprocessor.

4. The apparatus as claimed in claim 1, wherein the multimedia processor comprises a memory card processor and a video/audio processor, the memory card processor reads data on the selected memory card and the video/audio processor processed the data read from the memory card.

5. The apparatus as claimed in claim 1, wherein the microprocessor unit comprises input/output signal port to receive a signal from an operating panel.

6. The apparatus as claimed in claim 1, wherein the microprocessor unit comprises an IR signal port to receive a signal from a remote control.

7. The apparatus as claimed in claim 1, wherein the microprocessor unit comprises an audio/video output port.

8. The apparatus as claimed in claim 1, wherein the microprocessor unit comprises a digital data output port.

9. The apparatus as claimed in claim 1, wherein the microprocessor unit comprises a door open/close signal port to receive a door open/close signal.

10. The apparatus as claimed in claim 1, wherein the memory card is one of SD/MMC/MS/MS Pro/SM/XD to PCMCIA.

11. The apparatus as claimed in claim 1, wherein the memory card selecting unit comprises a plurality of memory card selecting switches.

12. The apparatus as claimed in claim 1, wherein the memory card is an SD card, and the memory card selecting unit reads the SD card by one of SD bus mode and SPI bus mode.
